(19) United States
(12) Patent Application Publication
(10) Pub. No.: US 2025/0080751 A1
(43) Pub. Date: Mar. 6, 2025

(54) MACHINE LEARNING MODEL FOR VIDEO WITH REAL-TIME RATE CONTROL

(71) Applicant: NEC Laboratories America, Inc., Princeton, NJ (US)

(72) Inventors: Mohammad Khojastepour, Lawrenceville, NJ (US); Srimat Chakradhar, Manalapan, NJ (US); Matin Mortaheb, College Park, MD (US)

(21) Appl. No.: 18/816,444

(22) Filed: Aug. 27, 2024

Related U.S. Application Data
(60) Provisional application No. 63/535,406, filed on Aug. 30, 2023.

(51) Int. Cl. H04N 19/149; H04N 19/172

(52) U.S. Cl. CPC H04N 19/149; H04N 19/172

(57) ABSTRACT

Methods and systems for rate control include determining an encoding parameter value to use for an input set of video frames based on a current channel capacity, using a machine learning model that accepts the input set of video frames and the current channel capacity as inputs. The input set of video frames are encoded using the encoding parameter to generate encoded video that has a bitrate below the current channel capacity. The encoded video is transmitted.

### RELATED APPLICATION INFORMATION

This application claims priority to U.S. Patent Application No. 63/535,406, filed on Aug. 30, 2023, incorporated herein by reference in its entirety.

### BACKGROUND

### Technical Field

The present invention relates to streaming video transmission and, more particularly, to real-time rate control for video encoding.

### Description of the Related Art

Channel quality for transmission of real-time information, particularly when using wireless communications, can vary as environmental conditions change. For example, a user with a mobile device may travel quickly from one condition to another, causing the transmission paths to change drastically from one moment to the next. Even between a stationary transmitter and receiver the channel conditions may change as objects such as people and vehicles move through the environment.

### SUMMARY

A method for rate control includes determining an encoding parameter value to use for an input set of video frames based on a current channel capacity, using a machine learning model that accepts the input set of video frames and the current channel capacity as inputs. The input set of video frames are encoded using the encoding parameter to generate encoded video that has a bitrate below the current channel capacity. The encoded video is transmitted.

A system for rate control includes a hardware processor and a memory that stores a computer program. When executed by the hardware processor, the computer program causes the hardware processor to determine an encoding parameter value to use for an input set of video frames based on a current channel capacity, using a machine learning model that accepts the input set of video frames and the current channel capacity as inputs, to encode the input set of video frames using the encoding parameter to generate encoded video that has a bitrate below the current channel capacity, and to transmit the encoded video.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of a communications system that transmits video over a channel according to a maximum capacity of the channel, with an encoding parameter being dynamically adjusted according to real-time information about the channel quality, in accordance with an embodiment of the present invention;

FIG. 2 is a block diagram of a real-time rate controller that dynamically adjusts an encoding parameter according to real-time information about channel quality using a machine learning model, in accordance with an embodiment of the present invention;

FIG. 3 is a block/flow diagram of a method for training and using a machine learning model to transmit video with real-time rate control, in accordance with an embodiment of the present invention;

FIG. 4 is a block diagram of a healthcare facility that uses video monitoring with real-time rate control to assist in medical decision making, in accordance with an embodiment of the present invention;

FIG. 5 is a block diagram of a computing device that can perform video encoding with real-time rate control, in accordance with an embodiment of the present invention;

FIG. 6 is a diagram of an exemplary neural network architecture that can be used to implement part of the prediction head, in accordance with an embodiment of the present invention; and

FIG. 7 is a diagram of an exemplary deep neural network architecture that can be used to implement part of the prediction head, in accordance with an embodiment of the present invention.

### DETAILED DESCRIPTION OF PREFERRED EMBODIMENTS

Channel quality information, such as a channel quality index (CQI), can be reported to a transmitter by user equipment (UE) on a nearly instantaneous basis. This channel quality information represents the potential bandwidth cap for the channel between the transmitter and the UE. The UE can be used to dynamically update the encoding quality of transmitted video so that as much of the available bandwidth is used as possible, without exceeding the limits of the channel.

To accomplish this, a real-time rate controller is used that processes incoming video clips, made up of a set of video frames, to generate features representing the video clips. These features are processed by a prediction head, along with a current bandwidth cap for the channel, to generate an estimated quantization parameter (QP) for the channel. The estimated QP is then used to encode the set of video frames, which are then transmitted to the UE.

The estimated QP is selected to be just below the maximum bitrate for the channel. When a next set of video frames is provided the estimate may be updated to respond to changing channel conditions. For rapidly changing channel conditions, the number of video frames in a set may be reduced so that the QP estimate is updated more frequently.

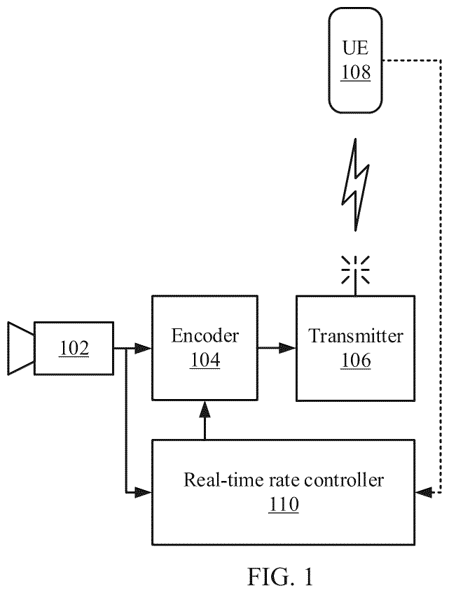

Referring now to FIG. 1, an exemplary video transmission system is shown. A video camera 102 captures frames of a scene within its field of view and outputs image data. Each captured frame is encoded by encoder 104 to a compressed image that will consume less bandwidth during transmission and that can be decoded at a UE 108. The encoder 104 has the ability to adapt the encoding in accordance with a QP, where higher QP values correspond to smaller bitrates and lower visual quality of the decoded image at the UE 108.

A transmitter 106 transmits the encoded images to the UE 108, which receives and decodes them, making them suitable for viewing. The transmission is illustrated as being over a wireless medium, but it should be understood that the present principles may apply to any appropriate wired or wireless communications medium and protocol. The transmission is susceptible to channel effects, for example characterized by a signal-to-noise ratio that describes how environmental factors affect the ability of the UE 108 to receive the transmission without errors.

The UE 108 may identify a CQI, or any other appropriate representation of the channel quality, based on the received transmission. The UE 108 may then return the CQI to a real-time rate controller 110. In some cases the UE 108 may transmit the channel quality information back along the same channel as the transmission, for example using time division to schedule use of the channel between the transmitter 106 and the UE 108. In some cases the UE 108 may transmit the channel quality information by a separate channel with its own respective transmission properties.

The real-time rate controller 110 accepts the channel quality information and determines a QP. Thus after one or more frames have been encoded and transmitted to the UE 108, the UE 108 provides an up-to-date estimate of the channel conditions. That new estimate is used by the real-time rate controller 110 to update the QP for use in encoding a next set of one or more frames. In this manner the system can rapidly adapt to changing channel conditions.

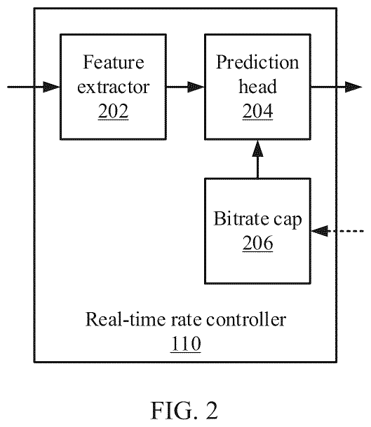

Referring now to FIG. 2, additional detail on the real-time rate controller 110 is shown. The frames from the camera 102 are provided as an input to the real-time rate controller 110, as well as channel quality information, to generate a QP as output. The real-time rate controller 110 may accept a group of such frames together, so that the QP output is used for encoding all of the frames in the group.

During encoding a set of video frames with a given QP, the actual bitrate of the encoded video stream is difficult to predict. While higher QP values generally correspond to higher bitrates, the visual and dynamic complexity of a group of video frames may influence the size of the resulting video. Thus an analytic or formulaic approach to QP selection can result in a condition where the bitrate exceeds the maximum capacity of the channel, which can result in dropped frames and other errors. Such errors are readily visible to a user, where the slight degradation in quality that results from selection of a somewhat higher QP value might not be noticeable. However, being too conservative in QP selection results in underused channel capacity.

QP selection may instead be performed using machine learning, where video features are extracted by feature extractor 202 from the video frames. These features are then processed by prediction head 204 which is trained to generate an encoding parameter to provide bitrates close to the channel capacity without exceeding it. It is specifically contemplated that the prediction head 204 may generate a QP value, but it should be understood that any appropriate encoding parameter may be used in accordance with an encoding standard used by the encoder 104. The machine learning model of the prediction head 204 is trained to recognize the bitrate needs of the input video frames and balance that with the limits imposed by the channel.

The channel quality information is thus used to identify a bitrate cap 206 that represents the current available bandwidth of the channel. If more information is transmitted than this bitrate cap 206, some of it is likely to be unrecoverable by the UE 108.

The encoder 104 may process a group of video frames V to generate encoded video \tilde{V} with a particular height H, width W, and frame rate fps. The bitrate of \tilde{V} is expressed as b(V, QP) and depends on the quantization parameter QP. The encoded video \tilde{V} may then be encapsulated into container packets for transmission. For a channel with Rayleigh fading, having a channel coefficient h that is a circularly symmetric complex Gaussian with zero mean and variance σₙ², the supported transmission rate is:

$$r ( h ) = log ( 1 + \frac{P {\vert h \vert}^{2}}{{σ}^{2} G} )$$

where G models the capacity gap due to channel coding, which is the difference between a theoretical rate given by the above and a physical model, and P represents the average power. G may be assumed to be affixed number, and any dependency on the modulation and coding scheme may be ignored.

The channel coherence time represents how much time it takes for channel conditions to change significantly. In most circumstances the channel coherence time is relatively long compared to the duration of the set of video frames, and so the bitrate cap 206 can be assumed to be suitable for the entire duration of transmitting the set of video frames. In some circumstances, such as in a rapidly changing environment or when the UE 108 is moving quickly, the channel coherence time may be shorter than the duration of the set of video frames. In such circumstances, the number of video frames that are processed at once may be reduced to increase the frequency at which the QP estimate is updated.

If the encoded bitrate for a set of video frames is below the bitrate cap 206, then all of the container packets should be received without error. However, if the encoded bitrate exceeds the bitrate cap 206, some packets (and so some video frames) may be dropped. The variability of the channel bitrate r(h) is due to the fading nature of the channel h, and variations in the video bitrates of the sets of video frames have to be considered to ensure that the cap is not exceeded.

The feature extractor 202 may include convolutional neural network layers to recognize video content with dimensions of [B, T, W, H] and outputs features with exemplary dimension of [B, 196, T, W/16, H/16], where B is the batch size, T is the number of video frames in a segment, W is the width in pixels of the video frames, and H is the height in pixels of the video frames. Each batch may thus have T frames, with a total of B batches being used for training.

The prediction head 204 may be implemented as a deep neural network that includes multiple convolutional layers, each followed by a conditional group normalization (CGN) block. The CGN blocks normalize the output from the previous layer. The prediction head may take the bitrate cap 206 as a tensor of log₁₀(BRₘₐₓ) with a size [B, 1] as a conditioning factor. Each element in the tensor represents the bitrate cap for each video in the batch.

The prediction head may process the conditioning factor through three linear layers, each with a Gaussian error linear unit (GELU) activation function, which transforms the tensor size to [2B, 1]. The tensor may then be split into two tensors, γ and β, of size [B, 1]. The γ and β tensors are used to adjust the normalized output from the preceding layer using the formula γ×output+β to train the video feature to discern QP values across different input video examples with varying bitrate caps 206.

Training data to train the prediction head 204 may include sets of a group of video frames V, a specified target quantization parameter QP_{target}, and a corresponding bitrate BR_{target} linked to the QP_{target}. The video frames V are used as an input to the feature extractor 202 with BR_{target} as the conditioning factor for the CGN blocks. The outcome generated by the prediction head is an estimate [symbol] . To train the prediction head, the following loss function may be optimized:

$$ℒ = {ℒ}_{CE} ( , {QP}_{target} )$$

where [symbol] _{CE} is a cross-entropy loss.

During training, the target bitrate BR_{target} is not strictly treated as an upper bitrate limit. During testing, there is therefore the possibility that the estimated QP is slightly lower than the QP value that guarantee a bitrate below the bitrate cap 206. This rounding effect can be mitigated by using slightly higher QP values (corresponding to lower quality encodings) than the estimated QP value when encoding data. This adjustment effectively prevents the occurrence of unwanted and destructive artifacts at the UE 108, while adding only a negligible drop in video quality. The adjustment to the QP may be set by running examples using different video feeds to identify a typical adjustment amount.

The precise structure of the prediction head 204 may depend on the particular dimensions and type of information in the video frames. In one example, the prediction head 204 may include a three-dimensional (3D) convolutional layer having dimensions (196, 196, kernel=(3,3,3)), a CGN layer having dimensions (num groups=4, Condition), a GELU layer, a 3D convolutional layer having dimensions (196, 196, kernel=(1,1,1)), a CGN layer having dimensions (num groups=4, Condition), a GELU layer, a 3D convolutional layer having dimensions (196, 196, kernel=(3,3,3)), a CGN layer having dimensions (num groups=4, Condition), a GELU layer, a 3D convolutional layer having dimensions (196, 52, kernel=(1,1,1)), a CGN layer having dimensions (num groups=4, Condition), a GELU layer, a fully connected layer with dimensions (12480,3120) and a GELU activation, a fully connected layer with dimensions (3120,780) and a GELU activation, a fully connected layer with dimensions (780,195) and a GELU activation, and a fully connected layer with dimensions (195,52) to produce an output QP value between 1 and 52. The number 52 may be replaced by any appropriate number of QP divisions for a given encoding standard.

Each CGN layer of the prediction head 204 may process the condition (e.g., the bitrate cap 206) with a fully connected layer having dimensions (1,196) and a GELU activation, a fully connected layer having dimensions (196,392) and a GELU activation, and a fully connected layer having dimensions (392,392) to generate the tensor with dimensions [2B, 1]. This tensor may be split, as described above, into γ and β tensors, each having a dimension of 196. The group normalization (e.g., with a number of groups being set to four) is then performed on the output of the previous layer (e.g., the output of a 3D convolutional layer), and this normalized output is multiplied by γ, with the product being added to β.

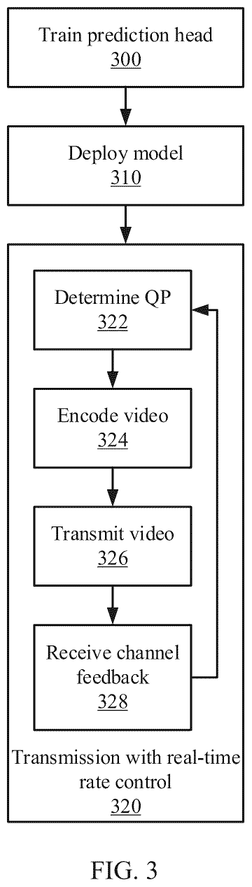

Referring now to FIG. 3, a method of training and using a real-time rate control model is shown. Block 300 trains the prediction head 204 as described above, using a set of training data. The training data may be any appropriate set of videos, with sets of video frames being encoded according to a variety of different QP values. To prepare the training dataset, each video may be partitioned into uniform chunks according to a number of frames (e.g., eight consecutive frames). The chunked videos may then be encoded using, e.g., 52 different QP values. The set of encoded video chunks may be sampled to create a training set and a testing set, and optimization of the parameters of the prediction head 204 may be performed in accordance with the loss function described above. The training 300 takes an input pair that includes a video chunk from the training dataset and a corresponding encoded bitrate and produces a predicted QP value. The predicted QP value is compared to the QP value used to encode the video chunk of the input pair.

The trained model is then deployed in block 310. This may include deploying the model as software in a camera device 102, for example as part of an encoding software module that operates on raw camera data.

During operation, block 320 transmits video data encoded with real-time rate control. This includes an iterative process where, for each successive set of video frames, block 322 determines the QP to use, block 324 encodes the video frames using the determined QP value, and block 326 transmits the encoded video to UE 108. Block 328 recites and processes channel quality information from the UE 108, which is used in block 322 to determine a new QP value for the next iteration.

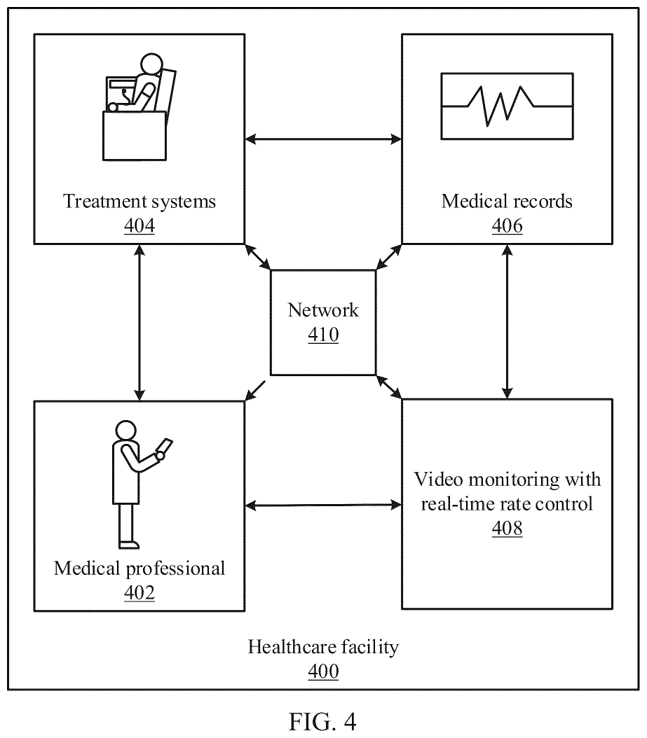

Referring now to FIG. 4, a diagram of information extraction is shown in the context of a healthcare facility 400. Video monitoring with real-time rate control 408 may be used to monitor patients in the healthcare facility 400 to ensure proper treatment and to avoid hazardous conditions. For example, the video monitoring can be used in conjunction with action detection to determine whether a patient is complying with a treatment regimen or is undertaking dangerous activities. The wireless transmission conditions within a healthcare facility 400 may change rapidly, for examples as doors open or close and as diagnostic equipment is turned on and off, with accompanying electromagnetic interference.

The healthcare facility may include one or more medical professionals 402 who review information extracted from a patient's medical records 406 to determine their healthcare and treatment needs. These medical records 406 may include self-reported information from the patient, test results, and notes by healthcare personnel made to the patient's file. Treatment systems 404 may furthermore monitor patient status to generate medical records 406 and may be designed to automatically administer and adjust treatments as needed.

Based on information drawn from the video monitoring with real-time rate control 408, the medical professionals 402 may then make medical decisions about patient healthcare suited to the patient's needs. For example, the medical professionals 402 may make a diagnosis of the patient's health condition and may prescribe particular medications, surgeries, and/or therapies.

The different elements of the healthcare facility 400 may communicate with one another via a network 410, for example using any appropriate wired or wireless communications protocol and medium. Thus video monitoring with real-time rate control 408 obtains information about a patient and updates the medical records 406 with the relevant visual information. The video monitoring with real-time rate control 408 may further output video for review by a medical professional 402. In some cases, the video may be used to coordinate with treatment systems 404 in some cases to automatically administer or alter a treatment. For example, if the video indicates a dangerous condition, then the treatment systems 404 may automatically halt the administration of the treatment.

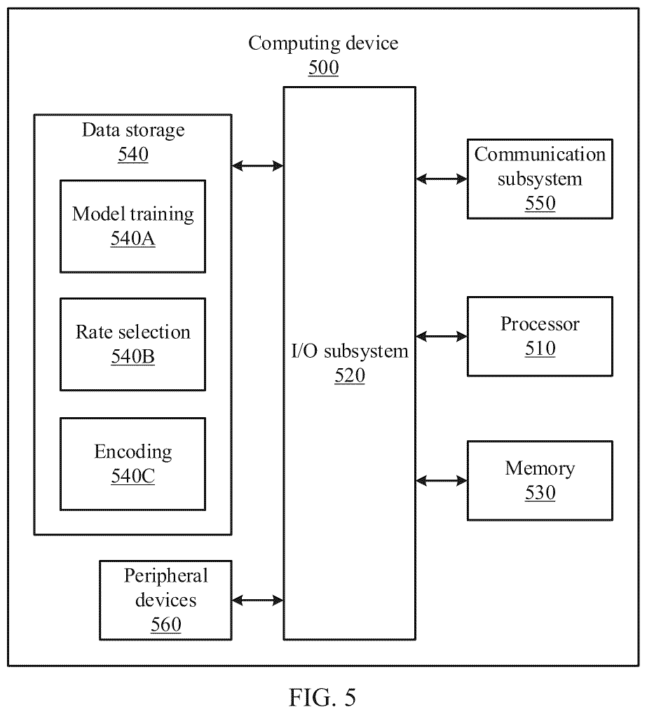

As shown in FIG. 5, the computing device 500 illustratively includes the processor 510, an input/output subsystem 520, a memory 530, a data storage device 540, and a communication subsystem 550, and/or other components and devices commonly found in a server or similar computing device. The computing device 500 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 530, or portions thereof, may be incorporated in the processor 510 in some embodiments.

The processor 510 may be embodied as any type of processor capable of performing the functions described herein. The processor 510 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 530 may be embodied as any type of volatile or non-volatile memory or data storage capable of performing the functions described herein. In operation, the memory 530 may store various data and software used during operation of the computing device 500, such as operating systems, applications, programs, libraries, and drivers. The memory 530 is communicatively coupled to the processor 510 via the I/O subsystem 520, which may be embodied as circuitry and/or components to facilitate input/output operations with the processor 510, the memory 530, and other components of the computing device 500. For example, the I/O subsystem 520 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 520 may form a portion of a system-on-a-chip (SOC) and be incorporated, along with the processor 510, the memory 530, and other components of the computing device 500, on a single integrated circuit chip.

The data storage device 540 may be embodied as any type of device or devices configured for short-term or long-term storage of data such as, for example, memory devices and circuits, memory cards, hard disk drives, solid state drives, or other data storage devices. The data storage device 540 can store program code 540A for training a model, 540B for selecting a QP value for encoding video, and/or 540C for encoding the video. Any or all of these program code blocks may be included in a given computing system. The communication subsystem 550 of the computing device 500 may be embodied as any network interface controller or other communication circuit, device, or collection thereof, capable of enabling communications between the computing device 500 and other remote devices over a network. The communication subsystem 550 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 500 may also include one or more peripheral devices 560. The peripheral devices 560 may include any number of additional input/output devices, interface devices, and/or other peripheral devices. For example, in some embodiments, the peripheral devices 560 may include a display, touch screen, graphics circuitry, keyboard, mouse, speaker system, microphone, network interface, and/or other input/output devices, interface devices, and/or peripheral devices.

Of course, the computing device 500 may also include other elements (not shown), as readily contemplated by one of skill in the art, as well as omit certain elements. For example, various other sensors, input devices, and/or output devices can be included in computing device 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 500 are readily contemplated by one of ordinary skill in the art given the teachings of the present invention provided herein.

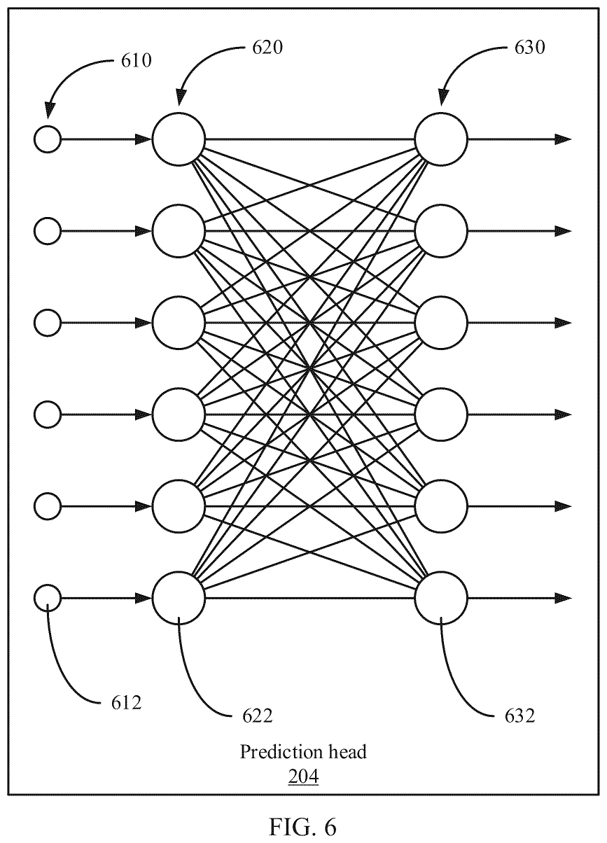

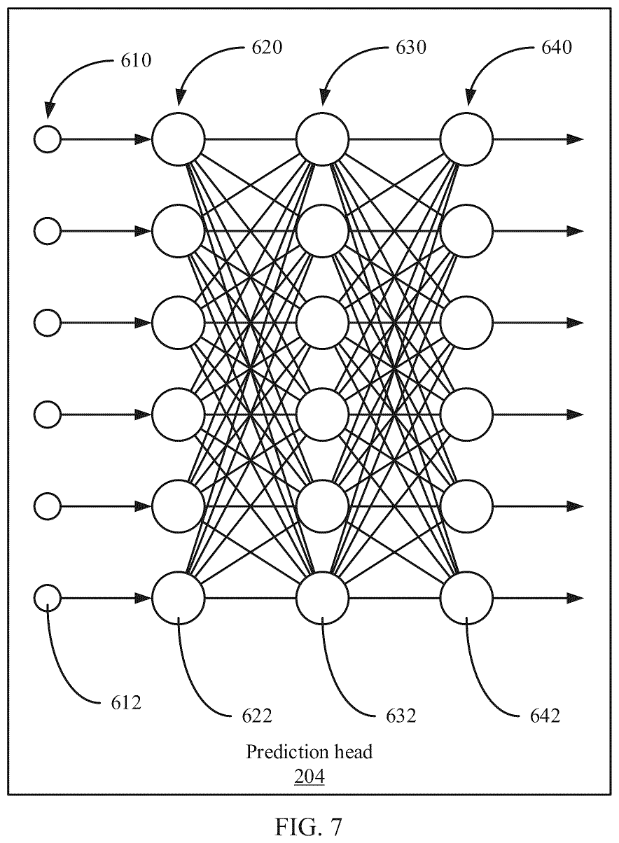

Referring now to FIGS. 6 and 7, exemplary neural network architectures are shown, which may be used to implement parts of the present models, such as the prediction head 204. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 620 of source nodes 622, and a single computation layer 630 having one or more computation nodes 632 that also act as output nodes, where there is a single computation node 632 for each possible category into which the input example could be classified. An input layer 620 can have a number of source nodes 622 equal to the number of data values 612 in the input data 610. The data values 612 in the input data 610 can be represented as a column vector. Each computation node 632 in the computation layer 630 generates a linear combination of weighted values from the input data 610 fed into input nodes 620, and applies a non-linear activation function that is differentiable to the sum. The exemplary simple neural network can perform classification on linearly separable examples (e.g., patterns).

A deep neural network, such as a multilayer perceptron, can have an input layer 620 of source nodes 622, one or more computation layer(s) 630 having one or more computation nodes 632, and an output layer 640, where there is a single output node 642 for each possible category into which the input example could be classified. An input layer 620 can have a number of source nodes 622 equal to the number of data values 612 in the input data 610. The computation nodes 632 in the computation layer(s) 630 can also be referred to as hidden layers, because they are between the source nodes 622 and output node(s) 642 and are not directly observed. Each node 632, 642 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 632 in the one or more computation (hidden) layer(s) 630 perform a nonlinear transformation on the input data 612 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for rate control, comprising:
determining an encoding parameter value to use for an input set of video frames based on a current channel capacity, using a machine learning model that accepts the input set of video frames and the current channel capacity as inputs;
encoding the input set of video frames using the encoding parameter to generate encoded video that has a bitrate below the current channel capacity; and
transmitting the encoded video.

2. The method of claim 1, further comprising determining the current channel capacity based on channel quality information received from user equipment.

3. The method of claim 1, wherein the machine learning model includes a prediction head model that is trained to generate a parameter value that, when used to encode the input set of video frames, results in the encoded video being at or below the current channel capacity.

4. The method of claim 3, wherein the prediction head model is a deep neural network model that includes conditional group normalization using the current channel capacity as a condition.

5. The method of claim 4, wherein the prediction head model includes a plurality of convolutional layers, each followed by a respective conditional group normalization.

6. The method of claim 1, wherein the encoding parameter is a quantization parameter.

7. The method of claim 1, further comprising altering the determined encoding parameter value to decrease video quality before encoding the video.

8. The method of claim 1, wherein determining the encoding parameter value includes extracting features from the input set of video frames and processing the features with the current channel capacity in a prediction head model.

9. The method of claim 1, wherein the encoded video is transmitted to a medical professional to aid in medical decision making.

10. The method of claim 1, further comprising performing a treatment action responsive to the encoded video, including automatically altering a patient's treatment in response to a patient activity shown in the encoded video.

11. The method of claim 1, wherein determining the encoding parameter value includes maximization of average video quality of a live video feed, subject to the current channel capacity available for the set of video frames and minimization of a probability of packet drop and video artifacts in transmission of the encoded video.

12. A system for rate control, comprising:
a hardware processor; and
a memory that stores a computer program which, when executed by the hardware processor, causes the hardware processor to:
determine an encoding parameter value to use for an input set of video frames based on a current channel capacity, using a machine learning model that accepts the input set of video frames and the current channel capacity as inputs;
encode the input set of video frames using the encoding parameter to generate encoded video that has a bitrate below the current channel capacity; and
transmit the encoded video.

13. The system of claim 12, wherein the computer program further causes the hardware processor to determine the current channel capacity based on channel quality information received from user equipment.

14. The system of claim 12, wherein the machine learning model includes a prediction head model that is trained to generate a parameter value that, when used to encode the input set of video frames, results in the encoded video being at or below the current channel capacity.

15. The system of claim 14, wherein the prediction head model is a deep neural network model that includes conditional group normalization using the current channel capacity as a condition.

16. The system of claim 15, wherein the prediction head model includes a plurality of convolutional layers, each followed by a respective conditional group normalization.

17. The system of claim 12, wherein the computer program further causes the hardware processor to alter the determined encoding parameter value to decrease video quality before encoding the video.

18. The system of claim 12, wherein the computer program further causes the hardware processor to extract features from the input set of video frames and to process the features with the current channel capacity in a prediction head model.

19. The system of claim 12, wherein the encoded video is transmitted to a medical professional to aid in medical decision making.

20. The system of claim 12, wherein the computer program further causes the hardware processor to perform a treatment action responsive to the encoded video, including automatically alteration of a patient's treatment in response to a patient activity shown in the encoded video.
